(19) United States
(12) Patent Application Publication
(10) Pub. No.: US 2015/0082702 A1
(43) Pub. Date: Mar. 26, 2015

(54) Pivotally Mounted Window and Screen Assembly

(71) Applicant: Rudolph Walter, Springtown, PA (US)

(72) Inventor: Rudolph Walter, Springtown, PA (US)

(21) Appl. No.: 14/274,062

(22) Filed: May 9, 2014

Related U.S. Application Data
(60) Provisional application No. 61/880,419, filed on Sep. 20, 2013.

(51) Int. Cl. E06B 9/01; E06B 3/36; E06B 9/02; E06B 9/00; E06B 3/26

(52) U.S. Cl. CPC E06B 9/01; E06B 9/00; E06B 3/26; E06B 9/02; E06B 3/36; E06B 2009/015; E06B 2009/002
USPC 49/56

(57) ABSTRACT

Disclosed is a pivotally mounted window and screen assembly. The device includes a T-shaped vertical support bar that is hingedly attached to a screen and a window frame, in which a window sash is mounted. The window frame is adapted to swing outward, while the screen is adapted to swing inward so that the window sash is unobstructed and can swing open the full 180 degree range relative to the vertical support bar. The present invention further includes a locking mechanism that secures the window sash and the screen in an open position. In this way, a user can open the window to access and clean the exterior side of the window without extending any portion of the body outside of a building. The present invention may be constructed to be installed into any window opening of a building.

### CROSS REFERENCE TO RELATED APPLICATION

This application claims the benefit of U.S. Provisional Application No. 61/880,419 filed on Sep. 20, 2013. The above identified patent application is herein incorporated by reference in its entirety to provide continuity of disclosure.

### BACKGROUND OF THE INVENTION

1. Field of the Invention

The present invention relates to a reversible window. More specifically, the present invention pertains to a pivotally mounted window and screen assembly. The window and screen assembly of the present invention is pivotally mounted to a vertical support bar via pins and brackets to increase accessibility to an exterior surface of the window. In this way, the present invention allows homeowners and building owners to clean window exteriors while safely inside of a building.

Clean windows can be important to the aesthetic appeal of a building and clean windows are also important for practical purposes. Cleaning windows, however, can be an arduous task. Windows can be very difficult to reach, and therefore laborious to clean. To clean the windows thoroughly, it is desired to clean both sides of windows. It is impossible, however, to clean the exterior side of the windows from inside of a building when an individual cannot access the exterior side of the windows.

Additionally, it can be difficult to clean the exterior side of the windows from the outside of a building. Cleaning the exterior side of the windows can require an individual to climb onto a ladder, which can be dangerous. Other methods may require an assistance from a professional to clean the exterior side of the windows while standing on a supported scaffolding, aerial work platforms, or suspended platform or cradle to reach a window, which can be impractical for many residential buildings.

The present invention provides a pivotally mounted window and screen assembly designed to provide accessibility to both an interior and exterior sides of a window. The device includes a vertical support bar with a pivotally mounted screen and a window frame having a window sash mounted thereon. The sash and the screen may be removable to change the look of the window or to replace a broken sash and/or screen. It is preferred that the window frame and screen are pivotally mounted along the length of the vertical support bar via pins and brackets so that the screen, window frame, and the window sash that is attached to the window frame may rotate about the vertical axis of the support bar. In addition, a locking mechanism, such as a pressure lock, secures the sash and screen in an open position while a user is cleaning the exterior surface of a window. As such, the present invention allows the user to safely access to the exterior side of a window while inside of a building. This is particularly advantageous for use in high rise buildings and windows in inaccessible locations. The present invention can be constructed for installation onto any window opening of a residential or commercial building. Thus, in some embodiments, the windows of the present invention may be constructed to withstand severe weather conditions. Accordingly, the present invention is extremely versatile for use in various types of buildings.

2. Description of the Prior Art

Devices have been disclosed in the prior art that relate to reversible windows for residential and commercial buildings. These include devices that have been patented and published in patent application publications, and generally relate to reversible windows that are pivotally mounted in a window frame. Some of these devices describe swingable window panels that are pivotally mounted on a frame. Other devices describe a self-cleaning reversible window assembly comprising a photocatalytic layer that degrade contaminants on the window surface. These devices, however, do not disclose a pivotally mounted window and screen assembly that may be secured in an open position via a stopping mechanism. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 3,771,264 to Sawle discloses a reversible window assembly for a window opening that comprises a rectangular, sealed, dual-pane window unit which is mounted on axially aligned, horizontal trunnions for rotation about a vertical axis and within the associated window opening. Removable molding strips on the inside of the window replace the conventional permanent window stops and allow freedom of swinging movement of the window unit and its glass panes after a movable element of one of the side jamb assemblies is shifted to an out-of-the-way position so as to release the window unit entirely. A split, trunnion-receiving bearing facilitates complete window unit removal for glass replacement or repair purposes.

Similarly, U.S. Pat. No. 2,493,501 to Reinmuller discloses a window sash having a window pane reversibly supported within the window frame to permit the outside thereof to be extended inwards to permit cleaning the windows without requiring a user to project any part of the body outside of the building. The window includes a sash member having a rectangular opening for a window pane mounted in a suitable frame. The frame of the lower sash pivots horizontally while the frame in the upper sash pivots vertically.

U.S. Published Patent Application Number 2004/0149307 Hartig discloses a self-cleaning reversible window assembly comprising a photocatalytic layer deposited on two generally opposed major surfaces of a window. When the major surfaces are exposed to ultraviolet radiation, the photocatalytic layers chemically degrade organic contaminants deposited on the surfaces of the substrate, thereby cleaning the window surface. The window assembly is also reversible to allow either of the opposed major surfaces to be exposed to ultraviolet radiation.

The foregoing devices are directed toward a reversible window assembly that pivots about the central vertical or horizontal axis of a window pane. While the pivotal movement of these devices allow a user to access clean the exterior side of a window, these devices are limited in that they cannot fully swing or open. The present invention provides a pivotally mounted window and screen assembly that is attached along the length of the vertical support bar via pins and brackets so that the assembly may swing inward or outward. Additionally, none of the foregoing devices disclose a screen or a mesh panel wherein the same is used to prevent debris or insects from coming into the building while allowing fresh air to circulate.

Another device, U.S. Pat. No. 4,041,644 to Alcanzare discloses a reversible window having at least two identical sidewise swingable panels that are pivotally mounted on a window frame which is adapted to move horizontally on the main frame. The swingable panels are adapted to cover the entire space defined by the stationary main frame. While Alcanzare discloses a window frame adapted to pivot about the vertical axis of the frame, it is limited in the fact that the window frame swings in only one direction. Furthermore, Alcanzare does not disclose a hinged window frame and a screen that is pivotally mounted on the window frame. Accordingly, the device of Alcanzare does not deter debris from entering a building. On the other hand, the present invention provides a pivotally mounted window sash that is adapted to swing open the full 180 degree range relative to the vertical support bar in which the window sash is mounted. Additionally, the window sash may swing independently so that the screen of the present invention may remain closed to block debris from entering inside of a building.

U.S. Pat. No. 3,721,044 to Kvasnes discloses hinge means for reversible windows, wherein a window sash in one end is pivotally mounted in a frame by means of two pivots arranged on the sash. The pivots are positioned along the guide grooves in the frame, and the sash is supported on either side by two arms pivotally mounted in the frame, wherein a first arm is L-shaped and a second arm is linear. The Kvasnes device does not disclose a pivotally mounted screen, and is not designed for use with the same. In contrast, the window and screen assembly of the present invention is connected to the vertical support bar via pins and brackets in order to enable the assembly to pivot about a vertical axis to allow the user to clean the exterior surface of the window.

Another device, U.S. Pat. No. 4,571,885 to Hirayama discloses a reversible window with a movable rotatory shaft, wherein the shaft is attached near the central portion of the upper surface of an upper window frame of a window. The shaft is slideable, so that the window may be reversed by rotation. While the device of Hirayama allows a user to access the exterior surface of the window, the Hirayama device is limited in that it cannot swing inward. Furthermore, the device of Hirayama does not include a screen that filters debris and dust when the window is open.

Finally, U.S. Pat. No. 6,598,346 to Ohman discloses a device for turnable windows comprising a frame having a first side face and a second side face, each of the side faces of the frame including a longitudinal groove adapted to receive guide bushings on the sash that is pivotally mounted to the frame. Additionally, Ohman discloses a pair of link arms disposed on opposing sides of the frame to allow the window to open and rotate. While the device of Ohman allows the user to pivot or rotate the window, the Ohman device is limited in the fact that it requires a groove or a channel on the window frame to guide the bushings thereon. The present invention comprises a simple construction that allows a user to pivot the window and screen assembly via pins and brackets, hinges, or the like. In this way, the present invention facilitates easier installation, wherein the screen and the window are secured directly to the window frame.

The present invention is adapted to provide a window and screen assembly that allows air ventilation while filtering debris, wherein the screen and the window frame having a window sash are individually and pivotally mounted to a vertical support bar. The window frame is adapted to swing outward while the screen swings inward, thereby allowing the window sash to swing in either direction. The present invention will assist users with cleaning the exterior surface of a window by allowing the users to access the exterior surface of the window while inside of a building. It is submitted that the present invention is substantially divergent in design elements from the prior art, and consequently it is clear that there is a need in the art for an improvement to existing reversible windows. In this regard, the instant invention substantially fulfills these needs.

### SUMMARY OF THE INVENTION

In view of the foregoing disadvantages inherent in the known types of reversible windows now present in the prior art, the present invention provides a new and improved pivotally mounted window and screen assembly wherein the same can be utilized for positioning a window sash in various positions, thereby increasing the ease of cleaning the window from inside of a building.

It is therefore an object of the invention to provide a new and improved pivotally mounted window and screen assembly that has all of the advantages of the prior art and none of the disadvantages.

It is another object of the present invention to provide a new and improved pivotally mounted window and screen assembly having a window frame that is adapted to swing outward and a screen that is adapted to swing inward so that a window sash is unobstructed and can swing open the full 180 degree range relative to a vertical support bar.

Another object of the present invention is to provide a new and improved window and screen assembly that are pivotally mounted to a vertical support bar via pins and brackets in order to enable the window and screen assembly to pivot about the vertical axis of the vertical support bar.

Still yet another object of the present invention is to provide a new and improved pivotally mounted window and screen assembly that has a locking mechanism to secure the window and screen assembly in an open position.

Still yet another object of the present invention is to provide a new and improved pivotally mounted window and screen assembly that has a screen to filter debris from coming in through the open window.

Still yet another object of the present invention is to provide a new and improved pivotally mounted window and screen assembly that may be easily removed and replaced.

A final object of the present invention is to provide a new and improved pivotally mounted window and screen assembly that may be constructed to install onto any window opening of a building.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the window and screen of the present invention in a closed position.

FIG. 2 shows a close up top planar view of the present invention in a closed position.

FIG. 3 shows a perspective view of the window sash and the screen of the present invention in an open position.

FIG. 4 shows a close up top planar view of the window sash and the screen of the present invention in an open position.

FIG. 5 shows a perspective view of the window frame and the window sash of the present invention in an open position.

FIG. 6 shows a close up top planar view of the window frame and the window sash of the present invention in an open position.

### DETAILED DESCRIPTION OF THE INVENTION

References is made herein to the attached drawings. Like reference numerals are used throughout the drawings to depict like or similar elements of the pivotally mounted window and screen assembly. For the purposes of presenting a brief and clear description of the present invention, the preferred embodiment will be discussed as used for providing access to the exterior surface of the window from inside of a building. The figures are intended for representative purposes only and should not be considered to be limiting in any respect.

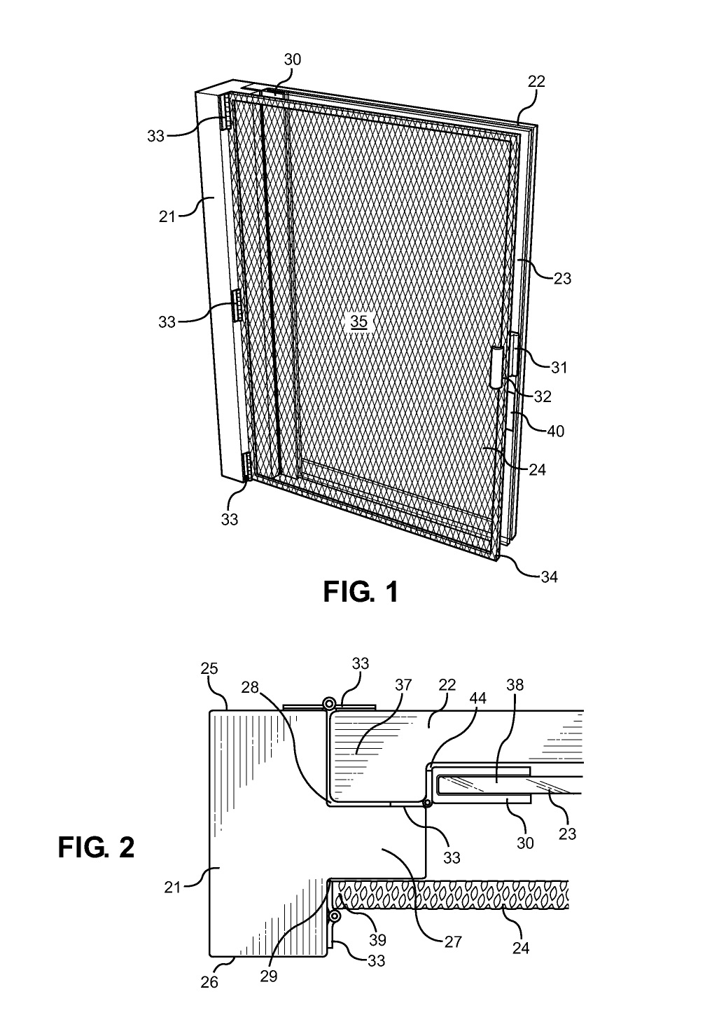

Referring now to FIGS. 1 and 2, there are shown views of the pivotally mounted window and screen assembly of the present invention in a closed position. The present invention comprises a vertical support bar 21, a pivotally mounted screen 24 and a window frame 22 having a window sash 23 mounted thereto. In the illustrated embodiments, the vertical support bar 21 and the window frame 22 is composed of wood. In other embodiments, however, the support bar 21 and the window frame 22 may comprise other suitable window framing material, such as vinyl, aluminum, and fiberglass. The vertical support bar 21 comprises a rod portion having two opposite ends 25, 26 and a protrusion portion 27 extending from approximately the midpoint of the rod portion. The protrusion portion 27 and the rod portion define a first corner 28 and a second corner 29 on opposing sides of the protrusion portion 27. In this way, the vertical support bar 21 has a generally T-shaped when viewed from the top.

The window frame 22 and the screen 24 are individually and pivotally attached to the vertical support bar 21 via a plurality of pins and brackets 33. The window sash 23 is pivotally attached to the window frame 22 via the plurality of pins and brackets 33. The pins and brackets 33 of the present invention are mounted using fasteners, such as screws and nails. Accordingly, the brackets comprise one or more apertures to receive the fasteners therethrough. Though it is preferred that the pins and brackets 33 are disposed along the top, middle, and bottom portion of the vertical support bar 21 along its length, the pins and brackets 33 may be disposed in other locations along the length of the vertical support bar 21. Additionally, other types of bearing such as hinges may be used.

The window frame 22 is generally rectangular in shape with a hollow middle, wherein its first longitudinal edge 37 is secured to the first corner 28 of the vertical support bar 21 via a plurality of pins and brackets 33 so that the frame 22 may swing outward toward the exterior of the building as it opens. The longitudinal edge 37 forms an L-shape corner 44 that fits into the first corner 28 of the vertical support bar 21. In a preferred embodiment, the window frame 22 includes pins and brackets 33 near the top, bottom, and the middle portion of its first longitudinal edge 37. The window frame 22 is constructed so that its height is substantially equal to the height of the vertical support bar 21. The window frame 22 is further dimensioned to fit into a window opening of a building when it is hingedly attached to the vertical support bar 21.

The present invention further includes a pivotally mounted window sash 23 comprising a rectangular glass member having an exterior surface and an interior surface, wherein the exterior surface faces the window frame 22 while the interior surface faces the screen 24. In the illustrated embodiment, the device comprises a single pane window. The window and screen assembly of the present invention, however, may be used with double or triple pane window. The window sash 23 is dimensioned to fit in the L-shape corner 44 of the window frame 22.

The window sash 23 also comprises an elongated metal binding 30 disposed along the first longitudinal edge 38 of the window sash 23. The metal binding 30 may be attached to the window sash 23 by means of press fit, epoxy, or other suitable fastening methods. The metal binding 30 comprises a plurality of pins and brackets 33 adapted to hingedly attach to the protrusion portion 27 of the vertical support bar 21, thereby pivotally mounting the window sash 23 to the L-shape corner 44 of the window frame 22. When the window sash 23 is mounted to the window frame 22, the exterior surface of the window sash 23 is adapted to rest flushly against the window frame 22 so that the sash 23 creates a seal to prevent vagrant breeze from outdoors when the assembly is in a closed position.

The window sash 23 further comprises a handle 31 disposed on its interior surface near a second longitudinal edge 43. The handle 31 is adapted to allow a user can open the window sash 23 by pulling or pushing on the handle 31. The handle 31 may comprise a variety of shape and size, and may be formed of various materials to suit the preferences of the user. In the illustrated embodiments, the handle 31 comprises a single elongated metal piece with a curved edge adapted for gripping.

The present invention also includes a pivotally mounted screen 24. The screen 24 comprises rectangular frame 34 with a meshed surface 35. The dimensions of the screen 24 is substantially equal to the dimensions of the window frame 22. The meshed surface 35 comprises a screen mesh attached to the rectangular frame 34 via screen spline or other suitable means. Accordingly, the frame 34 may include a groove or a channel to receive the screen spline. The screen 24 further comprises a plurality of pins and brackets 33 disposed along a first longitudinal edge 39 of the screen 24. The pins and brackets 33 are mounted to the second corner 29 of the vertical support bar 21 so that the screen 24 may pivot inward. The screen 24 also comprises a handle 32 disposed near the second longitudinal edge 42 of the screen 24. In this way, a user can open the screen 24 by pulling or pushing on the handle 32. The handle 32 may comprise a variety of shape and size, and may be formed of various materials to suit the preferences of the user. In the illustrated embodiments, the handle 32 comprises a single elongated metal piece with a curved end adapted for gripping.

The present invention further includes a locking mechanism 40 adapted to secure the window sash 23 and the screen 24 in an open position. In a preferred embodiment, the locking mechanism 40 comprises a pressure lock disposed along the second longitudinal edge 41 of the window frame 22. The locking mechanism 40 may comprise a mounting plate that is disposed in a cutout portion of a second longitudinal edge 41 of the window frame 22. The specific shape and type of the locking mechanism, however, is not of primary relevance with regard to the intent of the present invention, which portends to provide an improved pivotally mounted window and screen assembly that allows a user to access the exterior surface of the window.

The window and screen assembly of the present invention may be mounted to a window opening of a building using various methods known in the art. For instance, the window and screen assembly may be mounted after the perimeter of the window opening is sealed with sticky sheets of self-adhering waterproof membrane, strips of metal flashing, and caulk. Once the window and screen assembly is placed and set in the window opening, any remaining gap is filled with additional caulk or foam insulation.

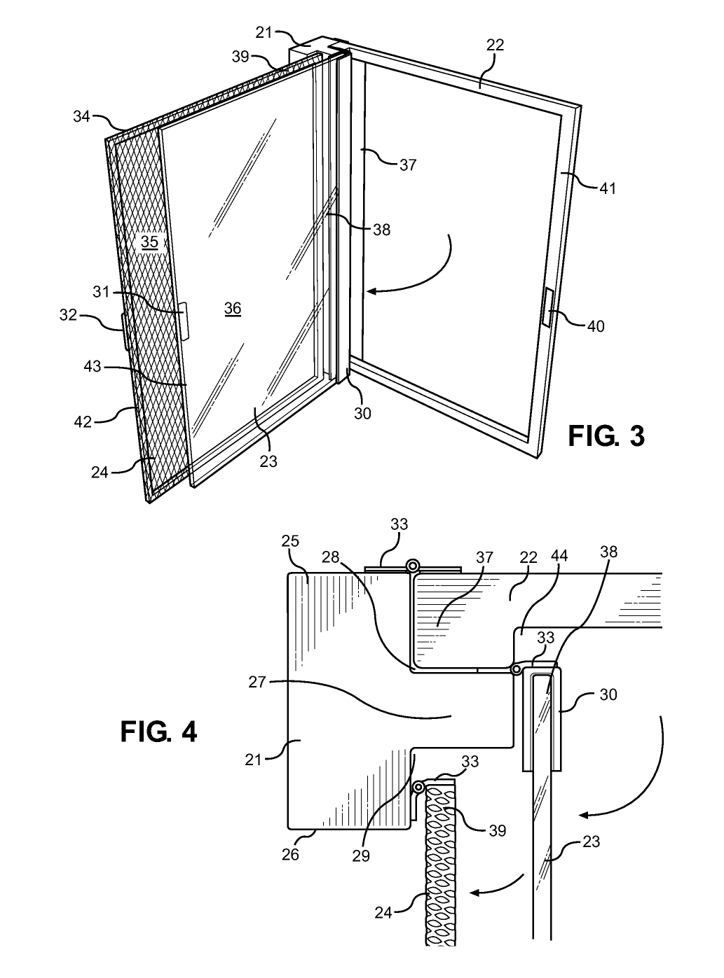

Referring now to FIGS. 3 and 4, there are shown views of the window sash 23 and the screen 24 of the present invention in an open position. The support bar 21 comprises a rod portion having two opposite ends 25, 26 and a protrusion portion 27 extending from approximately the midpoint of the rod portion. The protrusion portion and the rod portion define a first corner 28 and a second corner 29 on opposing sides of the protrusion portion 27. The protrusion portion 27 is adapted to provide a separation and offset between the window sash 23 and the screen 24. The first longitudinal edge 37 of the window frame 22 is secured to the first corner 28 of the vertical support bar via pins and brackets 33 disposed on the end 25 of the rod portion and the first longitudinal edge 37 of the frame 22. In this way, the protrusion portion 27 blocks the frame 22 from swinging inward.

The first longitudinal edge 39 of the screen 24 is secured to the second corner 29 of the vertical support bar 21 via pins and brackets 33 disposed near the second corner 29 and the first longitudinal edge 39 of the screen 24. When the screen 24 is mounted, the protrusion portion 27 blocks the screen 24 from swinging outward. In this way, the screen 24 may only swing inward. It is preferred, however, that the pins and brackets 33 limit the angle of rotation between the screen 24 and the vertical support bar 21 so that the screen 24 rotates 90 degrees about a fixed vertical axis of rotation in an inward direction.

The first longitudinal edge 38 of the window sash 23 is secured to the L-shape corner 44 of the window frame 22 via pins and brackets 33. More specifically, the window sash 23 is secured to the window frame 22 so that the hinge 33 of the window sash 23 forms a 90 degree angle when the window sash 23 is in a closed position and the hinge 33 forms a 180 degree angle when the window sash 23 is opened inwardly as shown in FIGS. 3 and 4. When the screen 24 is rotated about the vertical support bar 21, the window sash 23 is unobstructed and can swing 90 degrees relative to the vertical support bar 21 in an inward direction. Accordingly, the screen 24 and the window sash 23 may be opened at an angle orthogonal relative to the window frame 22. This allows a user to easily access and clean the exterior surface of the window while safely inside of a building. Furthermore, the screen 24 and the window sash 23 may be secured in an open position by engaging the locking mechanism disposed on the window frame 22 so that the user is able to clean the exterior surface of the window without moving the screen 24 and the sash 23.

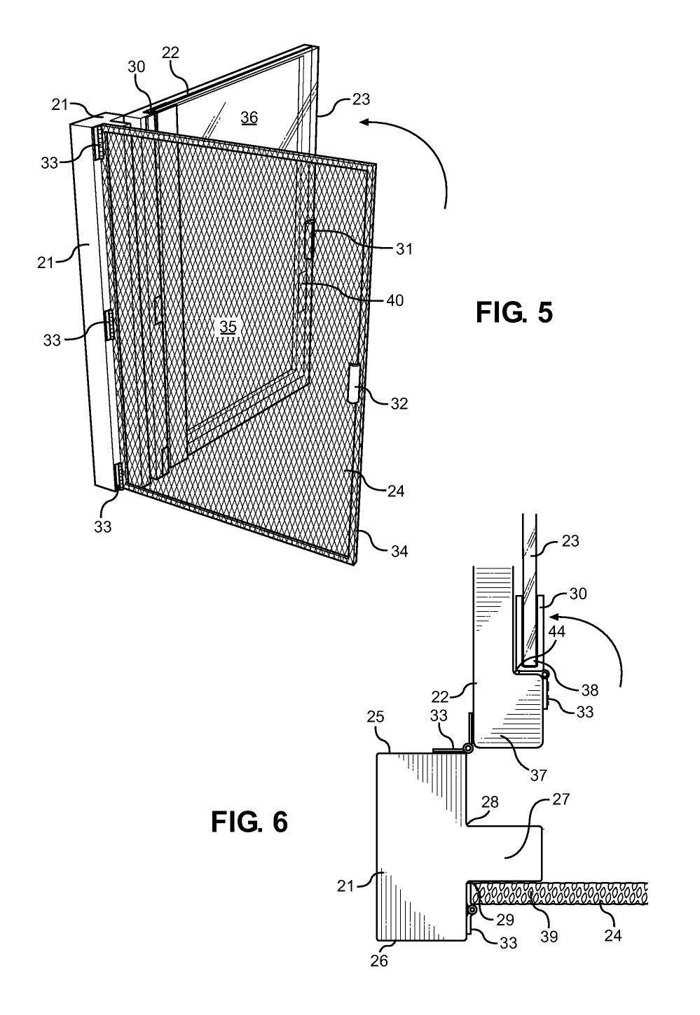

Referring now to FIGS. 5 and 6, there are shown views of the window frame 22 and the window sash 23 of the present invention in an open position. The first longitudinal edge 37 of the window frame 22 is secured to the first corner 28 of the vertical support bar via pins and brackets 33 disposed on the end 25 of the rod portion and the first longitudinal edge 37 of the frame 22. The pins and brackets 33 limit the angle of rotation between the window frame 22 and the vertical support bar 21 so that the frame 22 rotates 90 degrees about a fixed vertical axis of rotation in an outward direction. When the window frame 22 is rotated about the vertical support bar, the window sash 23 is unobstructed and can swing 90 degrees relative to the vertical support bar 21 in an outward direction. Accordingly, the window frame 22 and the window sash 23 may be opened at an angle orthogonal relative to the screen 24. When the window frame 22 and the window sash 23 are swung outward, the screen 24 may remain closed in order to prevent debris and insects from coming into the building while allowing fresh air to circulate therein.

The frame 22, the sash 23, and the screen 24 are able to individually pivot about the vertical axis of the vertical support bar 21. Because the window frame 22 is adapted to swing outward while the screen 24 is adapted to swing inward, the window sash 23 is adapted to swing open the full 180 degree range relative to the vertical support bar 21. This enables a user to access the exterior surface of the window sash 23 while inside of a building, thereby allowing the user to clean the exterior side of the window with ease.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A reversible window and screen assembly, comprising:
a vertical support bar having a rod portion and a protrusion portion;
said protrusion portion extending from approximately a midpoint of said rod portion;
said protrusion portion and said rod portion defining a first and a second corner on opposing sides of said protrusion portion;
a window frame having a window sash attached thereto;
a screen having a mesh surface affixed to a screen frame;
said window frame and said screen pivotally mounted along a length of said vertical support bar.

2) The reversible window and screen assembly of claim 1, further comprising:
a locking mechanism disposed on said window frame.

3) The reversible window and screen assembly of claim 2, wherein said locking mechanism comprises a pressure lock.

4) The reversible window and screen assembly of claim 1, wherein said protrusion portion is adapted to provide a separation and offset between said window sash and said screen when said window sash and said screen are closed.

5) The reversible window and screen assembly of claim 1, said window sash adapted to rest flushly against said window frame when said window sash and said window frame are closed.

6) The reversible window and screen assembly of claim 1, further comprising:
at least one set of pins and brackets adapted to pivotally mount said window frame and said screen to said vertical support bar length.

7) The reversible window and screen assembly of claim 1, further comprising:
at least one set of pins and brackets adapted to pivotally mount said window sash to said window frame.

8) The reversible window and screen assembly of claim 1, wherein said window frame comprises a first longitudinal edge having an L-shaped corner; and
said window frame first longitudinal edge is pivotally attached to said vertical support bar first corner to enable said window frame to swing in an outward direction.

9) The reversible window and screen assembly of claim 8, wherein said window sash comprises a first longitudinal edge having a binding, and said window sash first longitudinal edge is adapted to pivotally mount to said window frame L-shaped corner to enable said window sash to swing an inward and outward direction.

10) The reversible window and screen assembly of claim 9, wherein said binding comprises metal.

11) The reversible window and screen assembly of claim 9, wherein said window sash comprises an interior surface having a sash handle near a second longitudinal edge of said window sash.

12) The reversible window and screen assembly of claim 1, wherein said screen further comprises a first longitudinal edge that is pivotally attached to said vertical support bar second corner to enable said screen to swing in an inward direction.

13) The reversible window and screen assembly of claim 12, wherein said screen comprises an interior surface having a screen handle near a second longitudinal edge of said screen.

14) The reversible window and screen assembly of claim 1, wherein:
said window frame further comprises a first longitudinal edge pivotally attached to said vertical support bar first corner to enable said window frame to swing in an outward direction;
said window frame first longitudinal edge having an L-shaped corner;
said window sash further comprises a first longitudinal edge that is pivotally attached to said L-shaped corner to enable said window sash to swing in an inward and outward direction;
said screen further comprises a first longitudinal edge pivotally attached to said vertical support bar second corner to enable said screen to swing in an inward direction.

15) The reversible window and screen assembly of claim 14, wherein:
said window sash further comprises an interior surface having a sash handle near a second longitudinal edge of said window sash; and
said screen further comprises an interior surface having a screen handle near a second longitudinal edge of said screen.

16) The reversible window and screen assembly of claim 14, further comprising a locking mechanism.

17) The reversible window and screen assembly of claim 16, wherein said locking mechanism is a pressure lock.

18) The reversible window and screen assembly of claim 14, wherein said window sash first longitudinal edge comprises a metal binding.

19) The reversible window and screen assembly of claim 14, wherein said protrusion portion is adapted to provide a separation and offset between said window sash and said screen.

20) The reversible window and screen assembly of claim 14, wherein an exterior surface of said window sash rests flushly against an interior side of said window frame.

21) The reversible window and screen assembly of claim 1, wherein:
said window frame is adapted to pivot 90 degrees outward;
said window sash is adapted to pivot 180 degrees; and
said screen is adapted to pivot 90 degrees inward.
